(19) United States
(12) Patent Application Publication
(10) Pub. No.: US 2009/0181681 A1
(43) Pub. Date: Jul. 16, 2009

(54) Location service assisted transition between wireless networks

(75) Inventors: Marc John Hammond, West Sussex (GB); Poonvanpilli Gopal Madhavan, Singapore (SG)

Correspondence Address: IP Legal Services, 1500 East Lancaster Avenue, Suite 200, P.O. Box 1027, Paoli, PA, 19301, US

(73) Assignee: Agere Systems, Inc., Allentown, PA (US)

(21) Appl. No.: 12/287,507

(22) Filed: Oct. 9, 2008

Related U.S. Application Data
(63) Continuation of application No. 10/291,417, filed on Nov. 12, 2002.

(51) Int. Cl. H04W 36/00

(52) U.S. Cl. 455/440

(57) ABSTRACT

Location information available from a navigational system, such as the Global Positioning System (GPS) is used to transition a mobile client, such as a handset, between a Wide Area Network (WAN), such as a cellular telephone network, and a Wireless Local Area Network (WLAN), such as a system conforming to the 802.11 standard, (and vice versa), under user control and initiation, and may also be used to transition between two or more WLANs, for example, WLANs with different ranges and data rates. The transition is of a ‘break-before-make’ type, i.e. the mobile client is authenticated to the ‘new’ network via the ‘old’ network, disconnects from the ‘old’ network, and turns off the associated circuitry, turns on the circuitry needed to connect to the ‘new’ network, and then connects to it, overcoming problems such as mutual interference and receiver desensitization by transmitting only on one frequency band at any given time.

### BACKGROUND OF THE INVENTION

1. Field of the Invention

This invention relates to radio systems in which a mobile client can access alternative wide area and local area wireless networks. More particularly, the invention relates to transitioning between wide area and local area networks, and between more than one local area network.

2. Background of Related Art

In a mixed data-centric radio communications environment consisting of 2 (or more) coexisting but separate radio systems, it is desirable for a wireless mobile client to be able to connect to more than one system, and to be able to switch between different systems. Examples of component systems that it is desirable to be able to connect, a mobile client to include:

System A—A radio system in which the location and range is limited and short (high data rate, possibly unlicensed band usage, and low cost) member(s) (e.g. a Wireless Local Area Network (WLAN) conforming to the 802.11 standard). Quality of Service Information is provided in this System; and

System B—A radio system with a long range and ubiquitous coverage, i.e. a Wide Area Network (WAN), but having a low data rate (relative to System A), e.g. a GSM/GPRS cellular network, having a high data transfer cost/subscription. This system typically requires the mobile to transmit at high radio frequency power levels in long distance links.

In addition, in many circumstances it is desirable to be able to connect the mobile client to more than one distinct system of the general type of either System A or System B.

In this environment it would be of value to have a mobile client system (e.g. wireless, PDA) that combined these systems' client capability in a single device (for reasons of reduced Client System cost) that could Intelligently and beneficially transition in the following scenarios:

Scenario 1—Transition from System A to System B, e.g. because System A is out of range, and only System B is available;

Scenario 2—Transition from System B to System A, e.g. because System A is available and System A offers a cheaper higher quality data service than System B, however the Client System B capability has been turned off.

Scenario 3—Transition from System B to System A after the mobile circuit has picked up data informing them that more data is available, and selected a tag or link when it would be cheaper and quicker to obtain the additional information later when System A is available.

The general case is that the combined mobile client system is power consumption sensitive being a battery powered device, and/or that the mobile client is composed of a host system that supplies an enclosed wireless module (such as a PC Card) over a power constrained module interface. It would be necessary to turn off one client system A or B in a controlled manner to meet the individual radio systems regulatory requirements for the client radio system in this scenario.

Background art systems describe transitioning in a mixed radio system environment, however these relate to a situation in which both systems can coexist. These prior art systems fail to recognize or address problems associated with interference between radio transmissions in both systems. In such systems, a mobile client had to know by experience (memory) that it was in an area of System B coverage and manually switch in the client System B, because the radio systems employed in conventional mobile clients are sensitive and provide mutual interference.

There is a need for a better method and system allowing use of a device in both wide area networks and local area networks.

### SUMMARY OF THE INVENTION

In accordance with the principles of the present invention, a mobile client including first and second radio transmission modules is transitioned between two different networks by establishing a mobile client in a first network. The mobile client is transitioned from the first network to the second network by (1) ceasing transmission from the first radio transmission module in the mobile client associated with the first network, (2) initiating transmission from the second radio transmission module in the mobile client associated with the second network, and (3) connecting the mobile client to the second network.

### BRIEF DESCRIPTION OF THE DRAWINGS

Features and advantages of the present invention will become apparent to those skilled in the art from the following description with reference to the drawings, in which:

FIG. 1 shows a mobile client in relation to multiple radio systems.

FIG. 2 shows an arrangement with primary and secondary WLANs.

FIG. 3 shows an arrangement with multiple WLANs.

FIG. 4 is a flow chart of a transition from a WAN to a WLAN.

FIG. 5 shows transmit and receive passbands.

FIG. 6 shows passbands for multiple radio systems.

FIG. 7 shows a block diagram of circuitry according to an embodiment of the invention.

FIG. 8 shows a layout of circuit components on a PC card according to an embodiment of the invention.

### DETAILED DESCRIPTION OF ILLUSTRATIVE EMBODIMENTS

In accordance with the principles of the present invention, location Information available from a navigational system, such as the Global Positioning System (GPS) is used to beneficially transition a mobile client, such as a handset, between a Wide Area Network (WAN), such as a cellular telephone network, and a Wireless Local Area Network (WLAN), such as a system conforming to the 802.11 standard, (and vice versa), under user control and initiation. The invention may also be used to transition between two or more WLANs, for example, WLANs with different ranges and data rates.

The transition is of a ‘break-before-make’ type. In other words, the mobile client disconnects from one network, and turns off the associated radio circuitry, before turning on the radio circuitry needed to connect to another network and actually connecting to that network. This overcomes problems such as mutual interference and receiver desensitization by ensuring that the mobile client only transmits on one frequency band at any given time. To achieve this, the mobile client is authenticated to the ‘new’ network via the ‘old’ network.

As well as the previously mentioned systems of the type of System A or System B, systems of the following type are generally available at most locations:

System C—A radio System that provides interpretable location information capable of estimating System A's location and coverage (e.g. location estimation by triangulation and time difference in the TDMA (GSM/GPRS) Cellular System (i.e. some System Bs) or GPS (the Global Positioning System, in which use is free). This system may be considered low cost in use. This system may be part of System B or separate.

In the present invention, information from a navigational or location system of the general type of System C is employed to assist the mobile client in transitioning between systems of the general type of System A and/or System B, as will be more fully described with reference to the drawings.

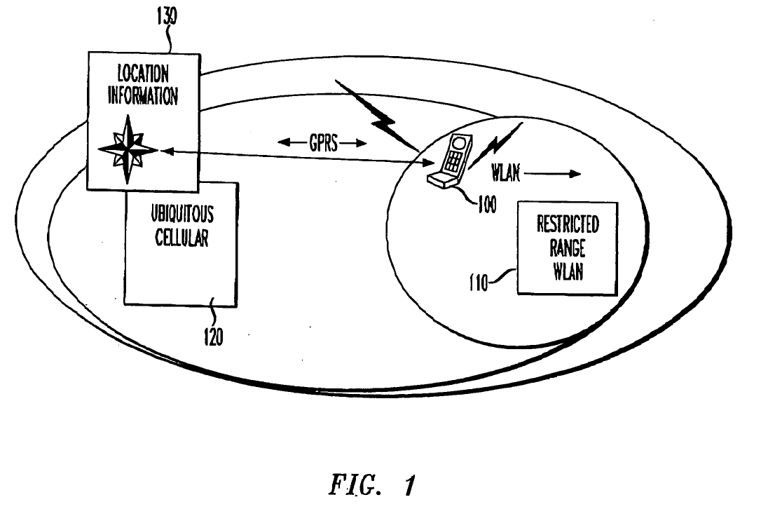

FIG. 1 shows a mobile client 100, e.g. portable telephone, in relation to a Wireless Local Area Network (WLAN) 110, a Wide Area Network (WAN) 120 (i.e. a cellular radio system), and a location system 130. The location system 130 may be any remote source of navigational information, such as for example a GPS navigational satellite.

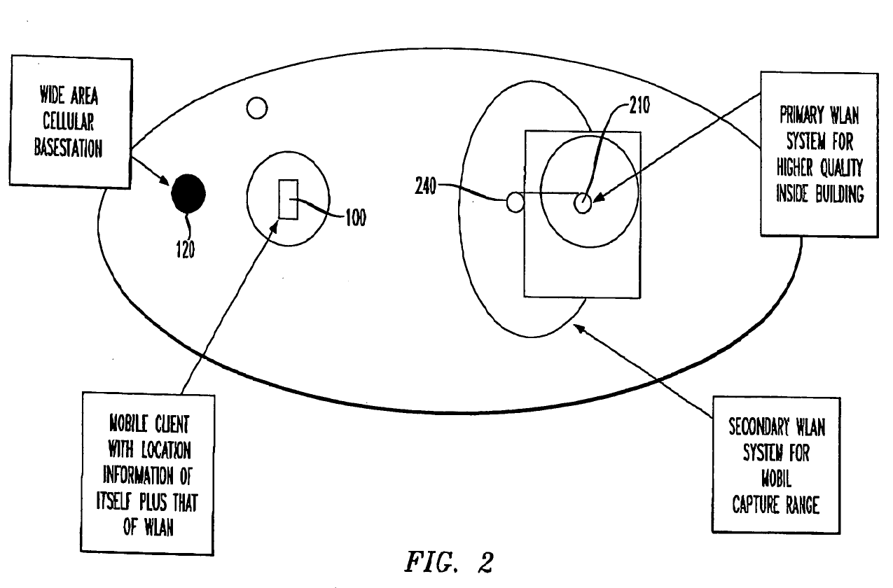

FIG. 2 shows a mobile client 100, a wide area cellular base station 120, a primary WLAN system 210 and a secondary WLAN system 240. Primary and secondary WLAN systems 210 and 240 may be used, for example, to provide coverage inside and outside a building. The primary WLAN system 210 has a higher data rate but a shorter range for use indoors, whereas the secondary WLAN system 240 has a lower data rate but a wider range for use outdoors.

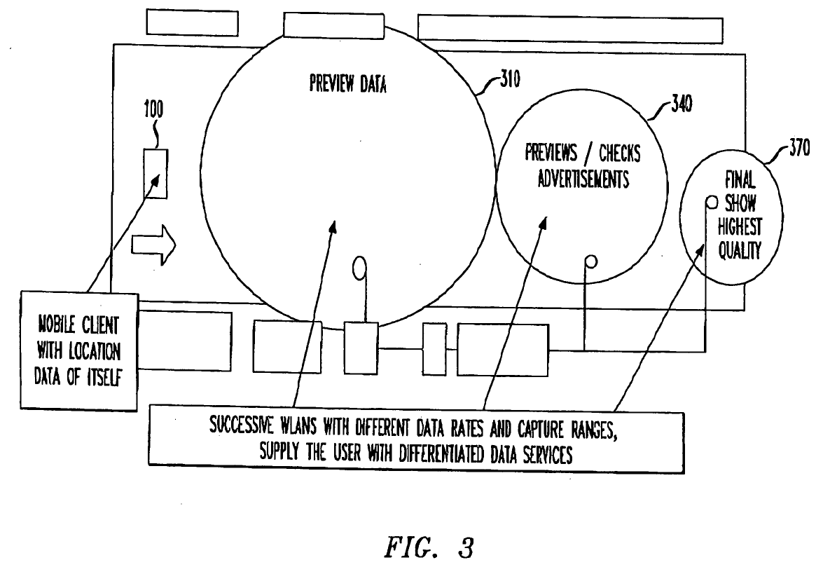

FIG. 3 is a representation of a street, showing a mobile client 100, and successive WLANs 310, 340 and 370. As a user passes along a street, they may access WLANs 310, 340 and 370 in turn, to access progressively higher data rate transmissions, each having a shorter range then the previous system but providing more detailed information.

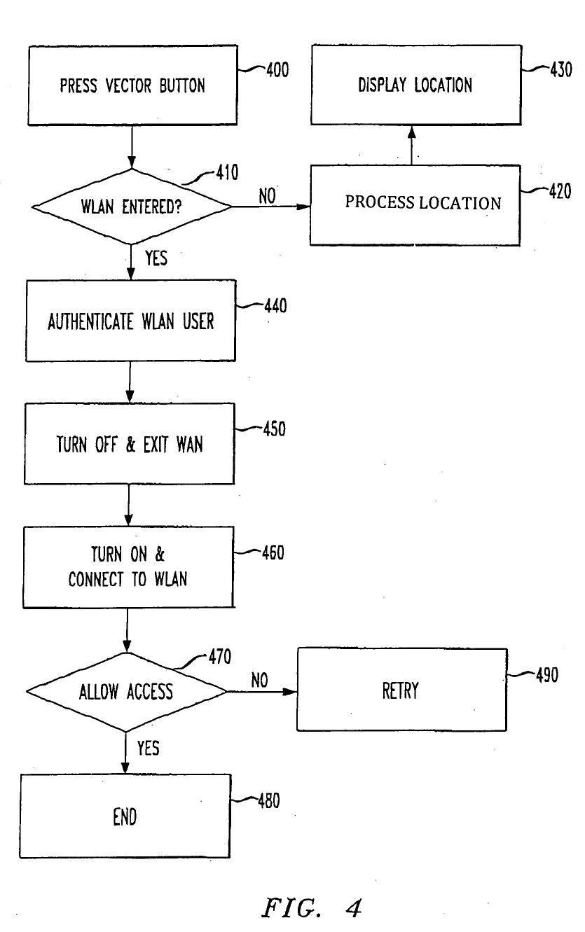

A flow chart of a transition from a WAN to a WLAN according to the invention is shown in FIG. 4. In step 400, the user presses a ‘Vector Button’ to enter a transition mode, and in step 410 a decision is made as to whether a WLAN capture area has been entered. If a WLAN capture area has not been entered, then in step 420 the client location relative to the WLAN is processed, and in step 430 the location is displayed. If a WLAN capture area has been entered, then in step 440 the user WLAN access is authenticated and the client configuration is pre-initiated, in step 450 the WAN module is turned off and the client exits the WAN, and in step 460 the WLAN module is turned on and the mobile client connects to the WLAN. Next, in step 470 a decision is made as to whether to allow the mobile client access to the WLAN. If the mobile client is allowed access the process is complete at step 480, and if the mobile client is not allowed access, it retries in step 490.

It will, of course be appreciated by those skilled in the art, that the steps involved in transitioning from a WLAN to a WAN, or between a plurality of WLANs having different ranges and data rates, are similar to the steps described above for transitioning between a WAN to a WLAN.

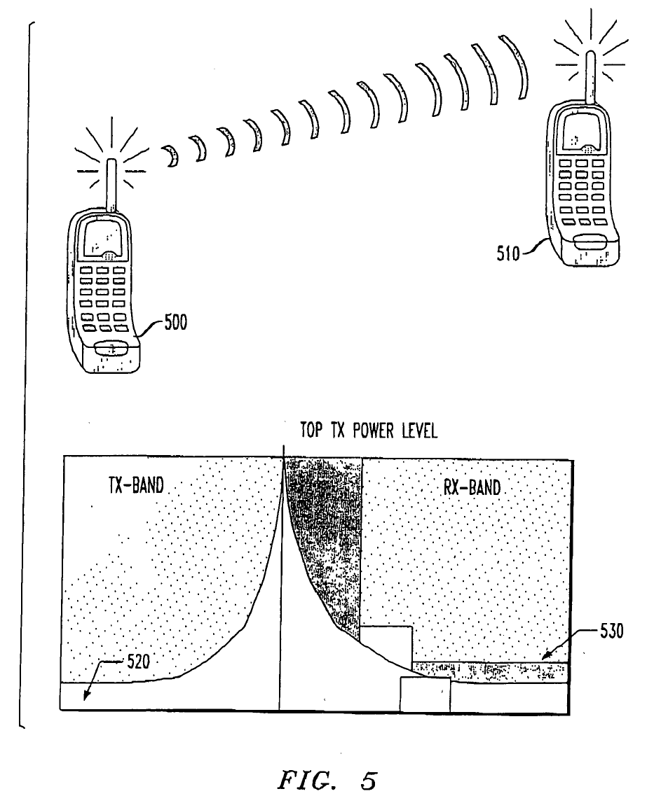

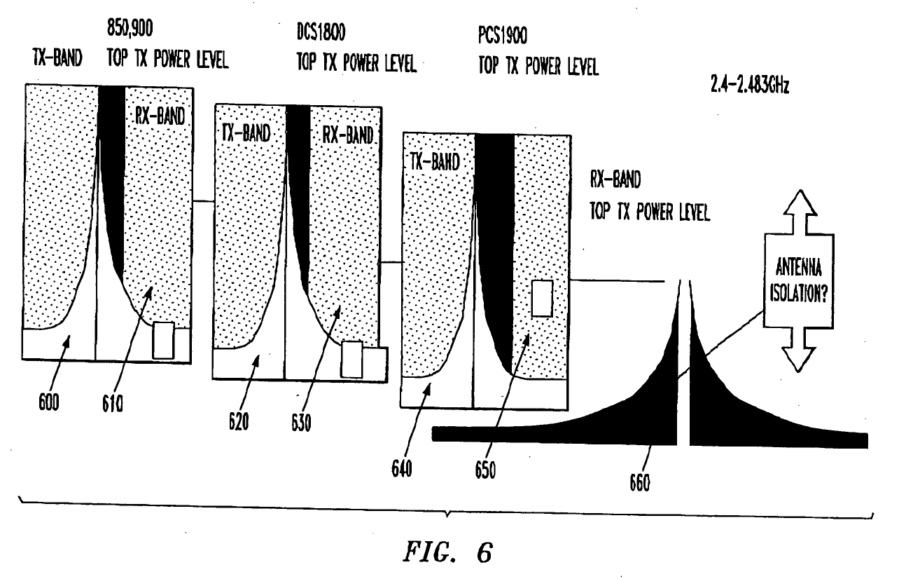

FIGS. 5 and 6 illustrate the separation in frequency between the various radio systems, to assist in understanding the potential for mutual radio frequency interference and receiver desensitization.

FIG. 5 shows first and second the mobile clients 500 and 510, and shows a transmit passband 520 and a receive passband 530 for GSM.

FIG. 6 shows transmit and receive passbands for various radio telephone systems. The transmit and receive passbands respectively are 600 and 610 for 850 and 900 MHz systems, 620 and 630 for DCS 1800 MHz systems, and 640 and 650 for PCS 1900 MHz systems and the passband for 2400-2483 MHz systems is shown at 660.

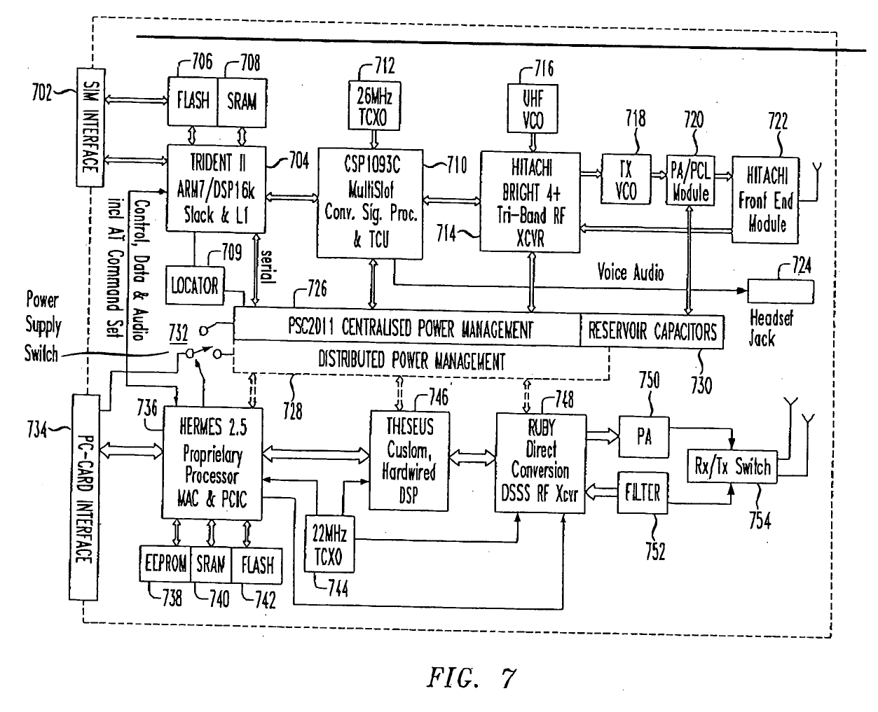

FIG. 7 shows a block diagram of a mobile client according to an embodiment of the invention. It will be appreciated by those skilled in the art that this illustrates only one of many possible implementations of the circuitry according to the invention, and that many implementations are possible without departing from the scope of the invention. A WAN circuit comprises a SIM interface 702, a Digital Signal Processor (DSP) 704 provided with flash memory 706 and SRAM 708, Assisted GPS locator hardware 709, a conventional signal processor 710 provided with an oscillator 712, a tri-band transceiver 714 provided with a voltage-controlled oscillator 716, a further voltage controlled-oscillator 718, a power amplifier module 720, a receiver front-end module 722 and a headset jack 724. Centralised power management 726 and optionally distributed power management modules 728 are provided, as well as reservoir capacitors 730 and a power supply switch 732. A WLAN circuit comprises a PC card interface 734, a proprietary processor 736 provided with EEPROM 738, SRAM 740 and flash memory 742, an oscillator 744, a DSP 746, a direct conversion direct sequence spread spectrum transceiver 748, a power amplifier module 750, a filter 752, and a transmit/receive switch 754.

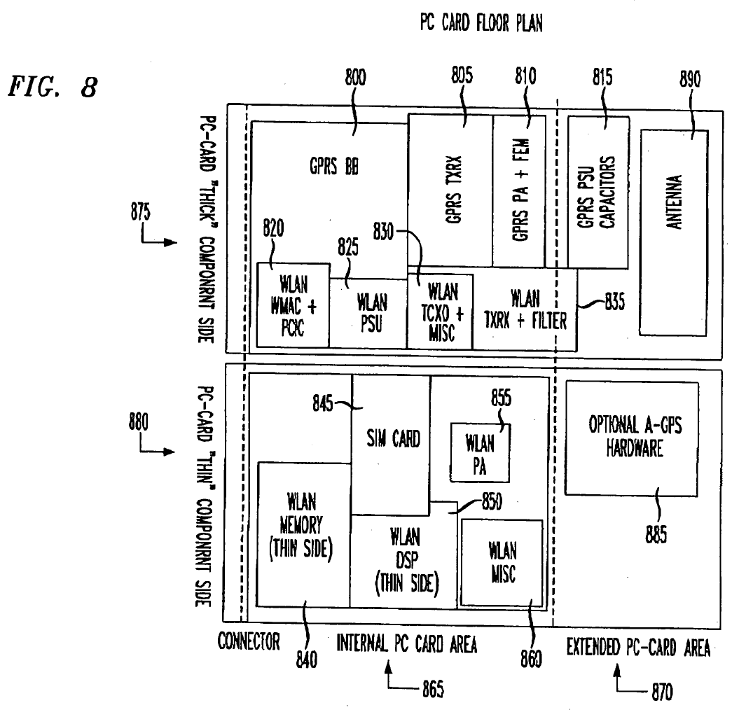

FIG. 8 shows a layout of a PC card for a mobile client according to an embodiment of the invention. The circuit blocks shown are a GPRS building block 800, GPRS transceiver 805, GPRS power amplifier 810, GPRS power supply 815, WLAN proprietary processor 820, WLAN power supply 825, WLAN oscillator 830, WLAN transceiver 835, WLAN memory 840, SIM card 845, WLAN DSP 850, WLAN power amplifier 855, miscellaneous WLAN circuits 860, optional Assisted GPS hardware 885 and antenna 890. The PC card is divided into an internal area 865 and an external area 870. The drawing shows both the thick component side 875 and the thin component side 880 of the board.

Generally, the present invention of a location assisted transition between WLAN and GPRS Cellular (WAN) services allows:
a) Access to the WLAN to be made easier and adaptable with Authentication and switch-over to be encapsulated from the user in time;
b) Authentication using the cellular Wide Area Network (WAN) messaging before transition to the Wireless Local Area Network (WLAN);
c) Effective and adaptable cost usage to take advantage of non Network Operator data networks when they are available;
d) Transitioning between the different radio systems, whilst minimizing RF interference;
e) Automatic transition to the use of a lower power RF system for data connection when available, thereby reducing the amount of high power radiation emitted by the mobile client device;
f) The assisted transition by location sets up a time and place in which differential wireless data services can be provided and related to the physical environment, e.g. buildings and street. In a data services capture range funnelling, or segmenting, e.g. see FIG. 3 for a plan view of a mobile user going down a street toward a cinema, and being provided with increasingly higher quality radio link material from networks 310, 340 and 370.

In Scenario 1 (see FIG. 1) a mobile client has both Wide Area Network (WAN) and Wireless Local Area Network (WLAN) systems, in which it is necessary to keep system power supply usage low, and data call costs down. The mobile client hardware may have restrictions in being able to supply sufficient electrical power to support the simultaneous operation of both radio client systems on the mobile client hardware for example a mobile client hardware consisting of a host system with the wireless systems as a removable module conforming to a host system power specification (such as a PC card). The mobile client also has restrictions in being able to operate both local (WLAN) and wide area (WAN) radio systems due to a mutual degradation of receiver sensitivity from radio frequency interference.

A mobile client moves from a data connection to a WLAN (System B), a GPRS data connection is disabled, the WLAN signal is lost due to range, so the mobile client makes an attachment to the more costly GPRS (System A). The mobile client Unit. switches OFF the WLAN Module within the mobile client and then switches on the GPRS system.

In Scenario 2 the mobile client is making a GPRS link but it would be more cost effective to use an available WLAN, and quality would be higher. However, the mobile client has turned off the WLAN for power reasons, for RF EMC (Electromagnetic Compatibility) interference reasons, or for RF coexistence reasons. The cellular specifications say that the mobile should remain ready to receive paging blocks, unless it is switched off and the cellular link disabled. The mobile client can however make the connection to the WLAN if it knows that it is in the region of coverage, by receiving location information. As the 802.11 WLAN standard allows data rate to be traded off for system range, it is conceivable that the WLAN System could be composed of a larger capture region 240 (e.g. the periphery of a building), around a higher data rate shorter range network 210 (in an office in the building), as shown in FIG. 2. The location Information would be received over the Cellular network (e.g. SMS, GPRS or WAP), or from a separate location system (e.g. GPS on the mobile client). The mobile client then determines if it should terminate its GPRS connection, power off the GPRS/GSM cellular, and then power up the WLAN system. This would be a “break before make” connection based on a priori information and decision making.

The mobile client could also use The time of this transition to initiate an authentication (or profile information passing) over the Cellular network (and back to the WLAN home network), before access is allowed to the WLAN.

The establishing of a transition time and place relative to a mobile client coming to WLAN based center could be used to pre-initiate some action ready for when the mobile client enters the WLAN area.

An example would be that a visiting sales representative wishes to show a presentation and do a maintenance check, The sales representative would receive the location information from the customer, and be guided to the Customers WLAN via the location information.

In these scenarios the present invention provides a ‘vector button’ on the mobile client to initiate and set the use of this intelligent transitioning. For example:

A mobile user is in an area of wide area System B, they receive a small e-mail text message, indicating that there is a large data file attachment associated with the e-mail. As it would be too costly to use System B to get this attachment, as well as other reasons, such as data rate, the user then presses the ‘vector button’ on the mobile client device to initiate the transition to System A.

The ‘vector button’ may of course be any form of button or switch, including an area on a touch screen, or may even be a voice actuated switching means, where the user speaks some appropriate word or phrase to initiate the transition. It is also contemplated within the scope of the invention that an automatic transition may take place under some circumstances.

While the invention has been described with reference to the exemplary embodiments thereof, those skilled in the art will be able to make various modifications to the described embodiments of the invention without departing from the true spirit and scope of the invention.

What is claimed is:

1. A method of transitioning a mobile client between two different networks, comprising:
establishing a mobile client in a first network, said mobile client including a first radio transmission module and a second radio transmission module;
verifying that said mobile client has entered a capture area of a second network; and
transitioning said mobile client from said first network to said second network, said transitioning comprising:
ceasing transmission from said first radio transmission module in said mobile client associated with said first network,
initiating transmission from said second radio transmission module in said mobile client associated with said second network, and
connecting said mobile client to said second network.

2. The method of transitioning a mobile client between two different networks according to claim 1, wherein:
said first radio transmission module transmits in a format different from a format used by said second radio transmission module.

3. The method of transitioning a mobile client between two different networks according to claim 1, wherein:
said first network is a wide area network (WAN).

4. The method of transitioning a mobile client between two different networks according to claim 1, wherein:
said second network is a wireless local area network (WLAN).

5. The method of transitioning a mobile client between two different networks according to claim 1, further comprising:
authenticating said mobile client for access to said second network.

6. The method of transitioning a mobile client between two different networks according to claim 5, wherein said verifying comprises:
determining a position of said mobile client;
determining whether said determined position of said mobile client is in said capture area of said second network.

7. The method of transitioning a mobile client between two different networks according to claim 6, wherein:
said position of said mobile client is determined by a navigational system in said mobile client.

8. The method according to claim 7, wherein:
said navigational system employs geostationary satellites.

9. The method of transitioning a mobile client between two different networks according to claim 7, wherein:
said navigational system is a global positioning satellite (GPS) system.

10. The method of transitioning a mobile client between two different networks according to claim 1, wherein:
said transitioning is initiated manually by a user of said mobile client.

11. The method of transitioning a mobile client between two different networks according to claim 10, wherein:
said transitioning initiates a user consent to access a data source via an automated, personalized, optimised process of selection of wireless services with the inclusion of privacy compliance and privacy authentication; and
said automated process provides relative and absolute information to the user;
whereby the user is enabled to choose to change their location to affect a better wireless services provision.

12. The method of transitioning a mobile client between two different networks according to claim 1, wherein:
said first network is a cellular telephone network; and
said second network conforms to an 802.11 standard.

13. Apparatus for transitioning a mobile client between two different networks, comprising:
means for establishing a mobile client in a first network, said means for establishing including a first radio transmission module and a second radio transmission module;
means for verifying that said mobile client has entered a capture area of a second network; and
means for transitioning said mobile client from said first network to a second network, said means for transitioning comprising:
means for ceasing transmission from said first radio transmission module in said mobile client associated with said first network,
means for initiating transmission from said second radio transmission module in said mobile client associated with said second network, and
means for connecting said mobile client to said second network.

14. The apparatus for transitioning a mobile client between two different networks according to claim 13, wherein:
said first radio transmission module transmits in a format different from a format used by said second radio transmission module.

15. The apparatus for transitioning a mobile client between two different networks according to claim 13, wherein:
said first network is a wide area network (WAN).

16. The apparatus for transitioning a mobile client between two different networks according to claim 13, wherein:
said second network is a wireless local area network (WLAN).

17. The apparatus for transitioning a mobile client between two different networks according to claim 13, further comprising:
means for authenticating said mobile client for access to said second network.

18. The apparatus for transitioning a mobile client between two different networks according to claim 17, wherein said means for verifying comprises:
means for determining a position of said mobile client;
means for determining whether said determined position of said mobile client is in said capture area of said second network.

19. The apparatus for transitioning a mobile client between two different networks according to claim 16, wherein said means for determining said position of said mobile client comprises:
a navigational system in said mobile client.

20. The apparatus for transitioning a mobile client between two different networks according to claim 19, wherein:
said navigational system employs geostationary satellites.

21. The apparatus for transitioning a mobile client between two different networks according to claim 19, wherein said navigational system comprises:
a global positioning satellite (GPS) system module.

22. The apparatus for transitioning a mobile client between two different networks according to claim 13, wherein:
said means for transitioning is initiated manually by a user of said mobile client.

23. The method of transitioning a mobile client between two different networks according to claim 22, wherein:
said means for transitioning initiates a user consent to access a data source via an automated, personalized, optimised process of selection of wireless services with the inclusion of privacy compliance and privacy authentication; and
said automated process provides relative and absolute information to the user;
whereby the user is enabled to choose to change their location to affect a better wireless services provision.

24. The apparatus for transitioning a mobile client between two different networks according to claim 13, wherein:
said first network is a cellular telephone network; and
said second network conforms to an 802.11 standard.
